(19) United States
(12) Patent Application Publication
(10) Pub. No.: US 2026/0227290 A1
(43) Pub. Date: Aug. 6, 2026

(54) BATTERY-FREE DIGITAL TIRE GAUGE

(71) Applicant: MEASUREMENT LTD., Kowloon (CN)

(72) Inventors: Steven PETRUCELLI, Cranbury, NJ (US); Jack KO, Shenzhen (CN)

(21) Appl. No.: 19/154,821

(22) PCT Filed: Feb. 8, 2023
(86) PCT No.: PCT/CN2023/075003

§ 371 Date: Aug. 8, 2025

(51) Int. Cl. G01M 17/02; G01L 17/00

(52) U.S. Cl. CPC G01M 17/02; G01L 17/00

(57) ABSTRACT

A battery-free tire gauge (10) comprising: a housing (20), an electronic circuit assembly (110) contained in the housing (20) and including at least one sensor (48, 120) for measuring at least one parameter associated with a tire, a control processor (1160), a display (100) coupled to the control processor (1160), and a charging capacitor (1110). A transformer (875) is coupled to a gear and ratchet assembly (70) in the housing (20) for transforming mechanical motion to electrical energy. A depressible handle (50) is operatively coupled to the housing (20) and mechanically coupled to the gear and ratchet assembly (70) whereby depression of the handle (50) towards the housing (20) drives the gear and ratchet assembly (70) to generate mechanical motion that is transformed into electrical energy by the transformer (875). The transformed electrical energy charges the charging capacitor (1110) to energize the control processor (1160) in the electronic circuit assembly (110) and cause the sensor (48, 120) to measure and display the at least one measured parameter.

### CROSS-REFERENCE TO RELATED APPLICATIONS

None.

### FIELD OF THE INVENTION

The present invention relates generally to sensing systems, and more particularly, to a battery-free digital tire gauge.

### BACKGROUND

Periodically checking a vehicle's tire pressures and tread depths is recommended to ensure safe and efficient operation. As such, tire pressure gauges are popular tools for a driver to have at his or her disposal, as are tread depth gauges. Such devices typically include electronic components useful for prompt, efficient, and accurate measurement and display of the relevant information. However, these electronic devices may consume significant energy resources, and typically require power sources such as batteries, cables, solar cells, and the like. Particular problems relate to charging and/or re-charging of such devices and energy sources. For example, significant environmental issues arise with respect to the manufacture, use, implementation, and/or disposal of batteries, cables, solar cells, and other such elements for powering tire gauges. Batteries (e.g. lithium ion batteries and/or other such energy sources typically used in digital tire gauges) are environmentally wasteful, corrosive, toxic, and require use of significant numbers of raw materials, chemicals, and other deleterious elements that adversely affect the environment. In addition, batteries are prone to thermal problems, increasing the potential for fire or explosion. Similarly, solar cells also have multiple negative effects due to their use of toxic chemicals, and have disposal and recycling issues, as well as the potential for excessive heat, among other issues. Furthermore, battery-powered devices require recharging and/or replacement, while real-time, on-demand use of the device is often required at critical times when such recharging or replacement is unavailable and significantly difficult.

Alternative structures and techniques for providing a tire gauge that mitigates one or more of the above problems are highly desired.

### SUMMARY

There is disclosed a battery-free digital tire gauge for measuring at least one parameter associated with a tire. The battery-free digital tire gauge of the present disclosure offers numerous improvements and advantages over battery powered tire gauges. The digital tire gauge of the present disclosure does not need approvals for transportation or shipping. There are no batteries that require disposal or replacement, and leakage concerns are also avoided. Further, while certain batteries (e.g. lithium coin cells) tend to be relatively safe, problems still occur due to excessive charging and/or problems with thermal malfunctions, fires, or explosive or volatile battery elements. Further still, batteries are often marginally charged and may fail at critical times when particularly needed. In the present disclosure, the battery-free digital tire gauge is configured to enable immediate, real-time and on-demand power, without concern as to the level of charge of a battery (as none exists), with no need for battery replacement, and further avoiding concerns as to storage, which battery powered devices (or solar cells) must take into account, in view of battery degradation due to potential temperature fluctuations in certain environments, such as excessive heat or excessive cold conditions (or lack of light for solar cells).

In an embodiment of the present disclosure, a battery-free digital tire gauge for measuring at least one parameter associated with a tire, comprising: a housing; an electronic circuit assembly in the housing including at least one sensor for measuring at least one parameter associated with a tire. The electronic circuit assembly further comprises a control processor, a display coupled to the control processor, and a charging capacitor. A transformer is coupled to a gear and ratchet assembly for transforming mechanical motion to electrical energy. A depressible handle (50) is operatively coupled to the housing, the depressible handle mechanically coupled to the gear and ratchet assembly located in the housing such that depression of the handle towards the housing drives the gear and ratchet assembly to generate mechanical motion that is transformed into electrical energy by the transformer. The transformed electrical energy resulting from the driven gear and ratchet assembly charges the capacitor in the housing to energize the electronic circuit assembly and cause the at least one sensor to measure the at least one parameter associated with a tire and display the at least one measured parameter on the display.

In one embodiment of the battery-free digital tire gauge, the housing comprises a body portion adapted to be held in the hand of a user and including an opening for receiving the end portion of the depressible handle; and wherein when the depressible handle is grasped in the hand of a user and squeezed in a substantially linear direction toward the body portion, the gear and ratchet assembly generates mechanical motion that is transformed into electrical energy by the transformer to charge the capacitor and energize the control processor in the electronic circuit assembly to enable the at least one sensor to measure at least one parameter associated with a tire and display the at least one measured parameter on the display.

In an embodiment of the disclosure, the electronic circuit assembly further comprises a low dropout voltage regulator; a charge pump low voltage detector for detecting when the capacitor voltage reaches a minimum threshold value; and a logic gate coupled to the input of the low dropout voltage regulator. The low dropout voltage regulator maintains a uniform voltage for energizing the microprocessor controller responsive to the charge pump low voltage detector determining the capacitor voltage is above a minimum threshold value and an active ON signal from the logic gate is received.

In an embodiment of the disclosure, the charge pump low voltage detector is electrically coupled to the charging capacitor for converting an analog voltage signal output from the charging capacitor to a predetermined digital voltage value for input to the low dropout voltage regulator when the charge pump low voltage detector determines the capacitor voltage is above the minimum threshold value. The charge pump low voltage detector is further configured to generate a signal when the capacitor voltage is less than the minimum threshold value to cause the microprocessor to perform an operational shut down. The LDO regulator operates in response to the low voltage detector to provide a constant (e.g. 3 V) output for powering the micro controller processor.

In an embodiment of the disclosure, the at least one sensor and the at least one parameter comprises a pressure sensor for sensing tire pressure, and a depth sensor for sensing tire tread depth. In one embodiment, the pressure sensor comprises a MEMs die. In one embodiment, the tread depth sensor comprises a variable resistor and movable rod or plunger for converting a mechanical displacement into an electrical analogue signal.

In an embodiment of the disclosure, the depressible handle comprises an end portion including a toothed rack. The toothed rack of the depressible handle is mechanically coupled to the gear and ratchet assembly located in the housing such that depression of the handle towards the body causes the toothed rack to drive the gear and ratchet assembly to generate the mechanical motion that is transformed into electrical energy by the transformer.

In an embodiment of the disclosure, the gear and ratchet assembly comprise: a first gear including a ratchet driving part; and a second gear including a ratchet structure. The ratchet driving part is configured for engaging with the ratchet structure of the second gear and driving the second gear to rotate in a first direction in response to squeezing of the depressible handle toward the housing to cause the toothed rack to drive the first gear to rotate in said first direction.

In an embodiment of the disclosure, the ratchet driving part comprises a pair of ratchet arm members disposed on opposite sides of the first gear. The ratchet structure of the second gear is positioned on an interior portion of the second gear and comprises a series of angled teeth for unidirectional engagement with the ratchet arm members. That is, in one rotational direction, the ratchet arm members are configured to engage with the ratchet structure to drive the second gear, while in the opposite rotational direction, the ratchet arm members are configured to slide over the ratchet structure such that the second gear is not driven in the opposite or reverse direction. In an embodiment, there is provided a support platform coupled to the first gear that supports the first gear with arm members coupled at opposite ends of the support platform. The first gear is positioned concentric with the second gear about a shaft along a vertical axis, with the first and second arm members disposed on a surface of the second gear orthogonal to the first axis, for engagement with the ratchet structure.

In an embodiment, the depressible handle with toothed rack is configured such that, by squeezing the handle, a spring force is applied and the toothed rack on the handle engages and drives the first gear, which drives the ratchet arm members rotating together, wherein the ratchet arm members engage with the ratchet structure on the second gear comprising a set of angled teeth, to drive the second gear of the gear assembly such that the engaged gear assembly rotates together to generate power via the transformer to be stored in the charge capacitor. Upon release of the depressible handle, the spring force causes retraction of the handle to a nominal position, while the ratchet structure prevents counter rotation of the remainder of the gear assembly. In this manner, the engaged gear system rotates together to cause the transformer to generate power for storage in the charging capacitor. When sufficient power resides in the capacitor, a consistent, predetermined voltage through the low dropout voltage regulator activates the control processor of the electronic circuit assembly for enabling tire gauge measurement and display.

### BRIEF DESCRIPTION OF THE DRAWINGS

FIG. 1A is a perspective view of a battery-free tire gauge according to an embodiment of the present disclosure.

FIG. 1B is a right-side view of the battery-free tire gauge of FIG. 1A.

FIG. 2 is an exploded view illustrating components in the interior of the housing according to an embodiment of the present disclosure.

FIG. 3 is a view illustrating components with the left side of the housing removed according to an embodiment of the present disclosure.

FIG. 4A is a view illustrating components with the right side of the housing removed and the handle in the retracted state according to an embodiment of the present disclosure.

FIG. 4B is a more detailed view illustrating ratchet and gear assembly portions of the components shown in FIG. 4A according to an embodiment of the present disclosure.

FIG. 5 is a view illustrating components with the right side of the housing removed and the handle in the fully depressed state according to an embodiment of the present disclosure.

FIG. 6A is a view illustrating components with the right side of the housing removed and the handle in the process of restoration into the retracted state according to an embodiment of the present disclosure.

FIG. 6B is a more detailed view illustrating ratchet and gear assembly portions of the components shown in FIG. 6A according to an embodiment of the present disclosure.

FIG. 7 is a more detailed view of a portion of the handle with pivot member and spring force according to an embodiment of the present disclosure.

FIG. 8 is a more detailed view of a portion of the ratchet and gear assembly of FIG. 4A.

FIG. 9 is a more detailed view of a portion of components of the ratchet and gear assembly of FIG. 4A from an underside opposite the view shown in FIG. 7.

FIGS. 10, 11, and 12 illustrate schematic circuit components and diagrams of the electronic circuit assembly of the battery-free tire gauge according to an embodiment of the disclosure.

Throughout the drawings, like reference numerals are used to indicate like parts.

### DETAILED DESCRIPTION

It is to be understood that the figures and descriptions of the present invention have been simplified to illustrate elements that are relevant for a clear understanding of the present invention, while eliminating, for purposes of clarity, many other elements found in temperature, pressure and depth measuring devices. However, because such elements are well known in the art, and because they do not facilitate a better understanding of the present invention, a discussion of such elements is not provided herein. The disclosure herein is directed to all such variations and modifications known to those skilled in the art.

In the following detailed description, reference is made to the accompanying drawings that show, by way of illustration, specific embodiments in which the invention may be practiced. It is to be understood that the various embodiments of the disclosure, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout several views.

### Architecture Overview

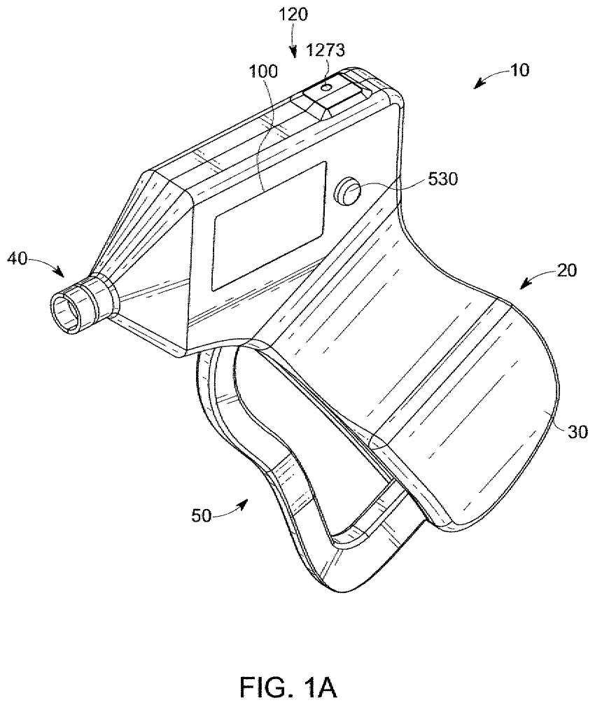

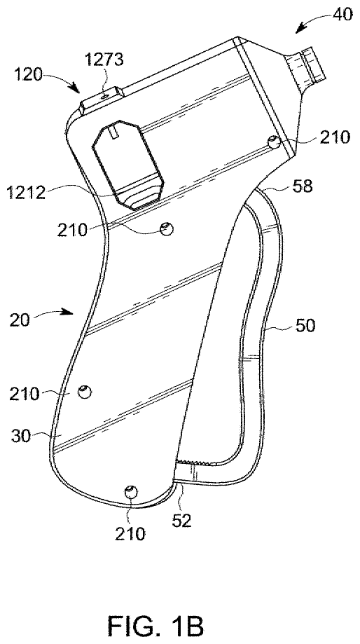

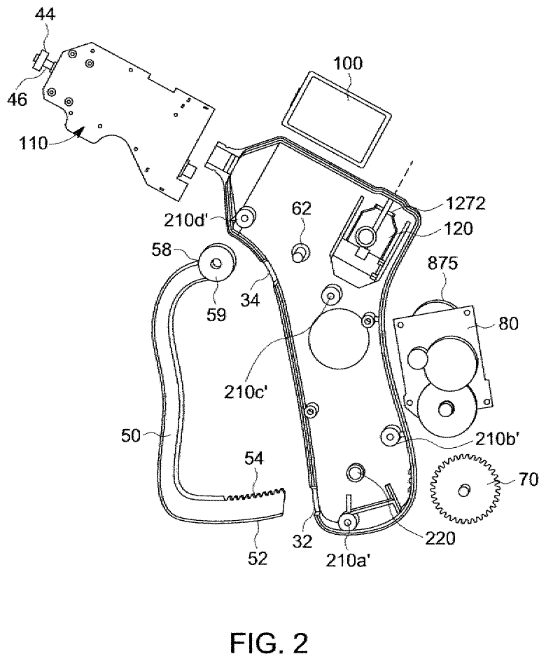

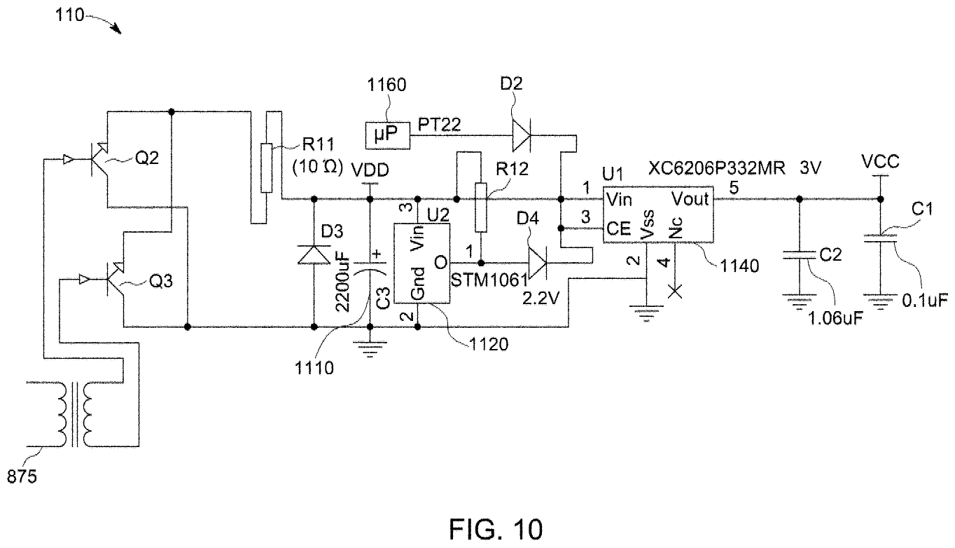

Referring generally to FIGS. 1-12, there is shown a battery-free tire gauge 10 for measuring at least one parameter associated with a tire. Gauge 10 comprises a housing 20 including a body portion 30 adapted to be held in the hand of a user. A depressible handle 50 is operatively coupled to the housing and mechanically coupled to a gear and ratchet assembly 70 (e.g. FIG. 2) located in housing 20 for generating mechanical energy when the handle is depressed in the direction towards the body portion of the housing. An energy transforming device 875 within the housing is responsive to the generated mechanical energy for transforming to electrical energy, which is supplied to a large charging capacitor 1110 (FIG. 10) for energizing and activating a control processor 1160. The energized control processor 1160 causes a sensor, such as pressure sensor 48 or tread depth sensor 120, to measure at least one parameter associated with the tire and display the at least one measured parameter on display 100.

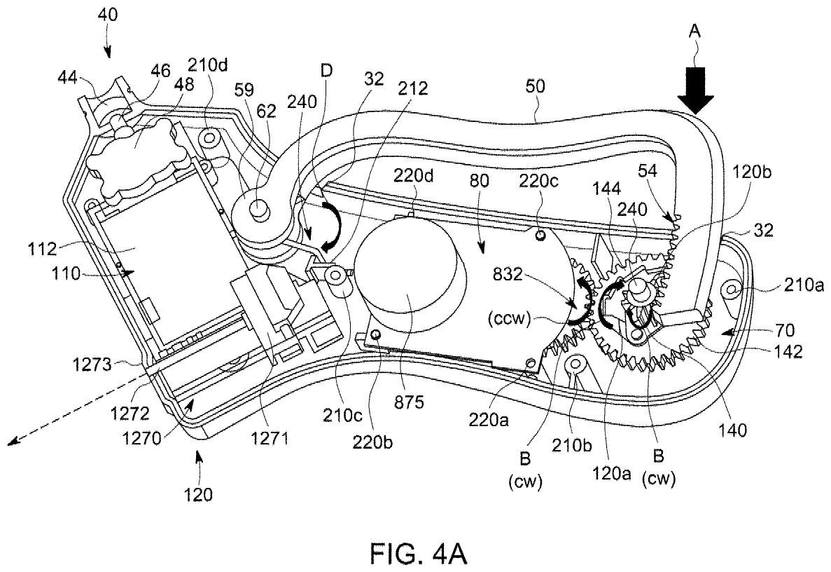

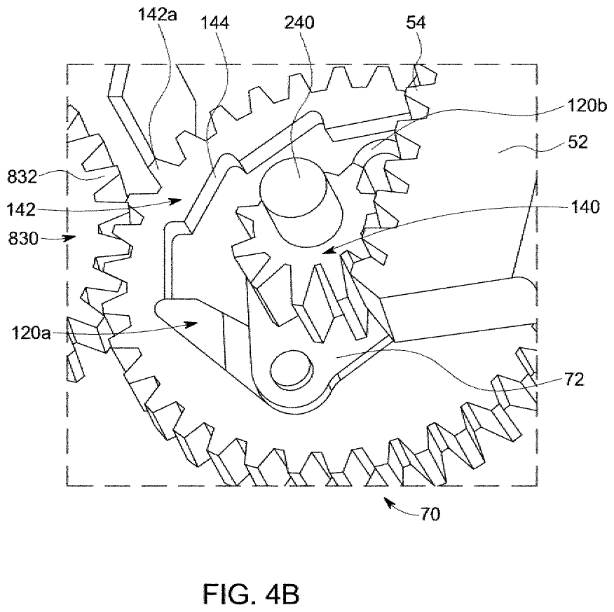

Tire pressure may be measured via nozzle 40, which includes a gasket 44 surrounding intake tube 46 that communicates pressure fluid to a pressure sensor 48 (FIG. 4A). By way of non-limiting example, pressure sensor 48 may be implemented as a piezo sensor, such as a diaphragm and semiconductor strain gauges connected in a bridge configuration, a capacitive sensor (e.g. fixed plate/moving plate), thin-film sensor, ceramic thick film sensor, MEMs sensor, and/or other such pressure sensing device, as is understood by one of skill in the art.

Tire gauge 10 may further and/or alternatively comprise tread depth measuring device 120. Tread depth measuring device 120 (see e.g. FIG. 4A) includes a variable resistor 1270 electrically connected to a printed circuit board 112 of electronic circuit assembly 110. As shown, a sliding block or lever 1271 is coupled to a measuring rod or tip 1272 movable along a longitudinal axis 1214 by driving portion 1212. The measuring rod 1272 is extendible out from the housing via opening 1273 by moving a slide (see FIG. 1B) on the outer surface of the housing along a longitudinal sliding slot of the upper portion of the housing. When moving the sliding block 1271 along the longitudinal sliding slot of the upper portion of the housing, the lever of the variable resistor 1270 is relatively moved, thereby causing the variable resistor to change the output of the resistance value. The variation of the resistance value is then converted into a corresponding frequency by a distance converting circuit in the control processor, and then converted into a readable distance reading for display on the screen of display 100.

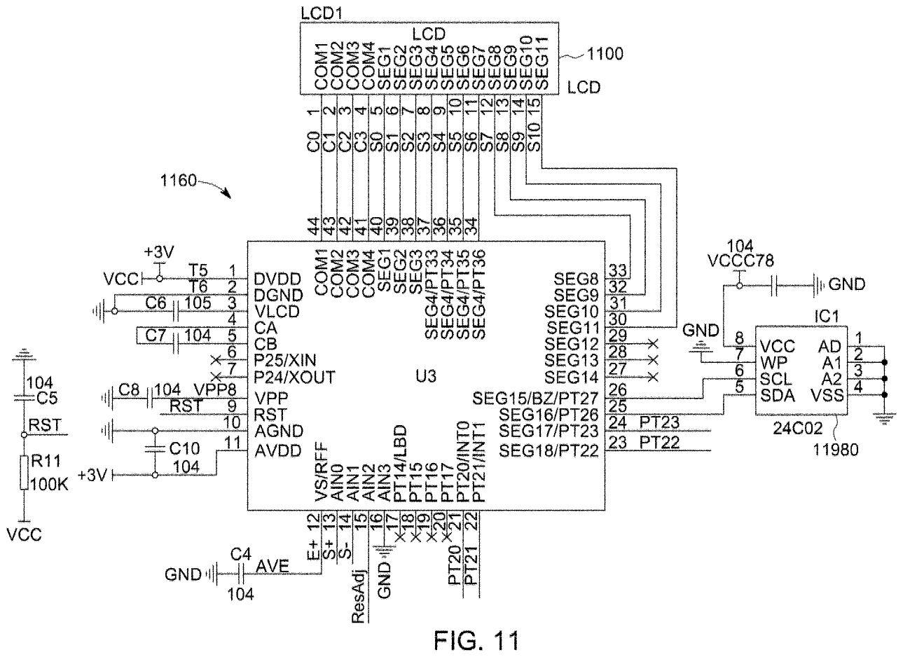

Electronic circuit assembly 110 is contained, for example, on printed circuit board 112 in housing 20 and includes a control electronics including a control processor (e.g. microcontroller) for controlling, receiving and processing the sensed data parameters from the pressure sensor 48 and tread depth sensor 120. The electronic circuit assembly comprises a control processor such as microprocessor 1160 (FIG. 11), display 100 (e.g. LCD 1100, FIG. 11) coupled to the control processor 1160, and a large capacitance charging capacitor 1110 (see FIG. 10) for energizing the control processor.

An energy transforming device such as coil transformer 875 (see FIG. 4A) is coupled to a gear and ratchet assembly 70 for transforming mechanical motion from the assembly to electrical energy. A depressible handle 50 is operatively coupled to housing 20, with handle 50 mechanically coupled to the gear and ratchet assembly 70 located in housing 20.

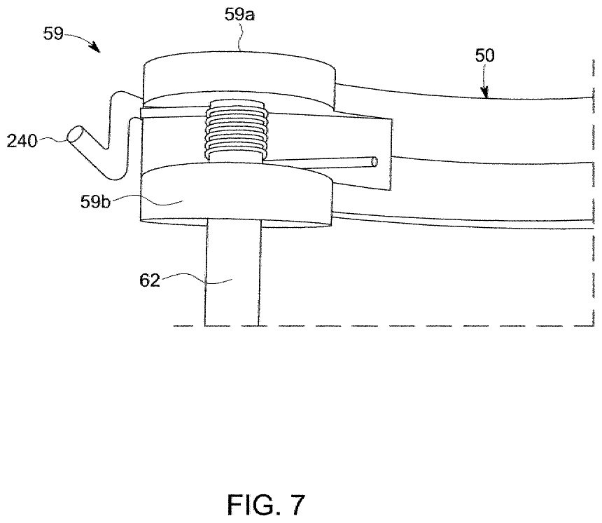

As best seen, for example, in FIGS. 2, 3, 4, 5, and 6, handle 50 includes a first end portion 52 and a second end portion 58 opposite the first end portion. First end portion 52 includes a relatively linear toothed rack 54 for engaging with first toothed gear 140 of gear and ratchet assembly 70. Second end portion 58 comprises a circular pivot member 59 with through hole pivotably coupled to a portion of the housing via shaft 62. Shaft 62 is secured via complementary support posts through a central portion of the pivot member 59. Pivot member 59 is configured to rotate about shaft 62 to a predetermined extent. Pivot member 59 includes spring force member 240 (see FIGS. 4A, 5, 6A, 7) disposed about shaft 62 and constrained between parallel sections 59a and 59b of pivot member 59 (FIG. 7). More particularly, spring 240 comprises a first end and a second end, with a central section coiled about the shaft 62 and retained between parallel sections 59a and 59b. As shown, the first end of spring 240 is distal from the pivot member and extends a predetermined distance therefrom for engagement with stop 210/212 (FIG. 4A) when handle 50 is depressed in the direction of the device housing. The respective ends 52 and 58 of handle 50 are received in housing openings 32 and 34 (e.g. see FIG. 2). As best shown in FIGS. 4, 6, and 7, when spring 240 is deformed (e.g. handle depressed) from its free state, the spring stores energy in the form of elastic potential energy, which is released when the spring is freed (e.g. handle released). It is understood that the housing and/or the handle may take various shapes or forms. However, in an embodiment, an important characteristic of the device is that the housing body is configured to be held in the hand of a user, and the handle positioned and configured such that it is capable of being grasped and depressed in a direction toward the housing (and subsequently released therefrom), to enable the rack portion 54 of the handle to move substantially in the direction toward the housing (and subsequently away therefrom) and engage with the ratchet assembly, along with pivoting of the opposite end portion 59 of the handle.

As shown in the drawings, complementary post connectors 210a-210d and 210a′-210d′ connect and secure the two sides of housing 20. Fasteners such as screws or other connectors may be inserted into the post connectors labeled generally as 210 (FIG. 1B) from an exterior surface of the housing to hold together or secure housing 20.

Housing support post 220 (FIG. 2) and counterpart support post (not shown) on the opposite half of housing 20 are configured to receive and retain shaft 240 for enabling rotation of the gear and ratchet assembly 70.

Support elements 220a-220d (FIG. 4A) are adapted to receive, support and secure the generator transmission gear mechanism 80 within housing 20.

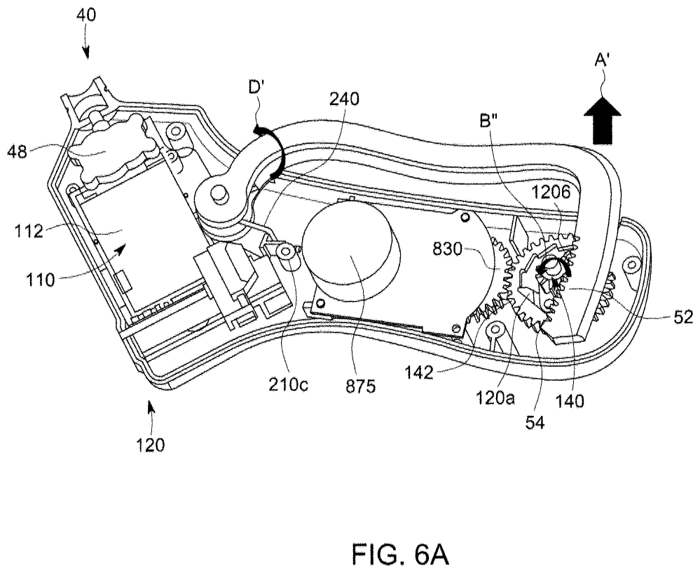

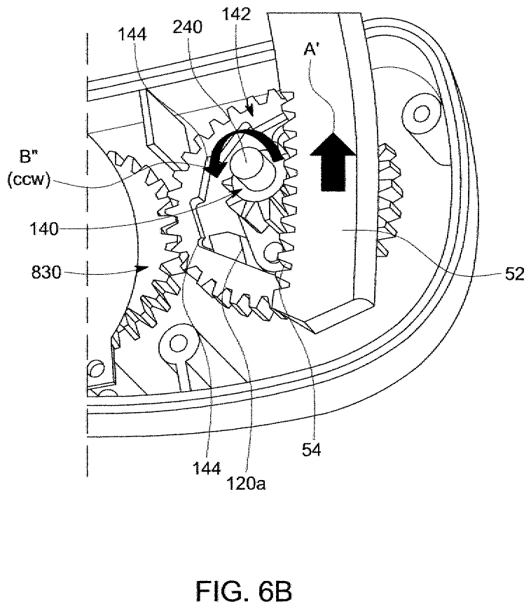

As best shown in FIG. 4A, support member 210c includes stop member 212 arranged as a barrier to stop the motion of spring 240 in the direction of arrow D when handle 50 is depressed (biased) in the direction (arrow A) toward housing 20. When the handle is released, spring 240 provides a restoration force (arrow D′) that moves the handle back to its initial (unbiased) position (arrow A′) as best shown in FIG. 6A.

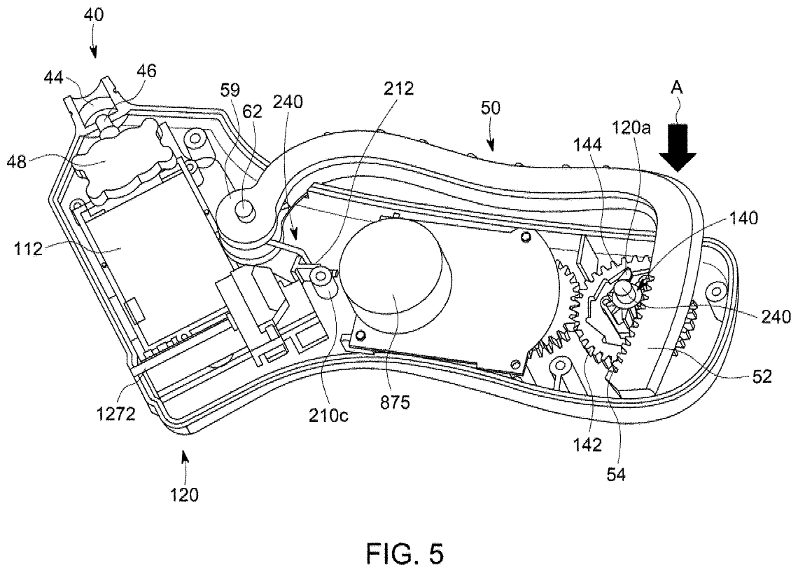

Still referring to FIGS. 4A-4B and FIG. 5 in conjunction with FIGS. 6A-6B and FIG. 7, applying a force F in the direction A by squeezing or depressing the handle 50 toward housing 20 causes the toothed rack portion 54 of handle end 52 engages with first pinion gear 140 to drive gear and ratchet assembly 70 to generate mechanical motion that is transformed into electrical energy by transformer 875. More specifically, when a user holds the housing of the hand-held device (e.g. in the palm of the hand) and grasps the handle (e.g. with the fingers) and squeezes, thereby applying a bias force F to the handle end 52 sufficient to overcome the spring force, this causes movements of the toothed rack portion 54 of the handle in the direction A, which in turn causes rotational motion of first pinion gear 140 in the rotational direction B. This in turn causes ratchet arm members or pawls 120a, 120b to index and engage the inner ratchet structure of the second gear 142 to rotate second gear in the same clockwise direction B′ as B. As is understood in the art, the ratchet structure 144 of second gear 142 comprise teeth that are uniform but asymmetrical, with each tooth having a moderate slope on one edge and a much steeper slope on the other edge. The ratchet arm members 120a, 120b index the inner pinion, which is spring loaded, and which applies force on the outer gear which runs the motor. The leaves in the pinion include a retention spring that clicks and holds into position, so as to transfer energy into the outer gear that drives the motor. In this manner, an energy storing spring is turned by the handle. The ratchet provides only unidirectional movement (preventing reciprocal or bidirectional motion), where the second gear 142 is locked by the ratchet. When the handle 50 is squeezed, rotation of second gear 142 causes external teeth 142a of second gear 142 to engage with external teeth 832 of third gear 830 to rotate the third gear counter to the direction of gears 140 and 142.

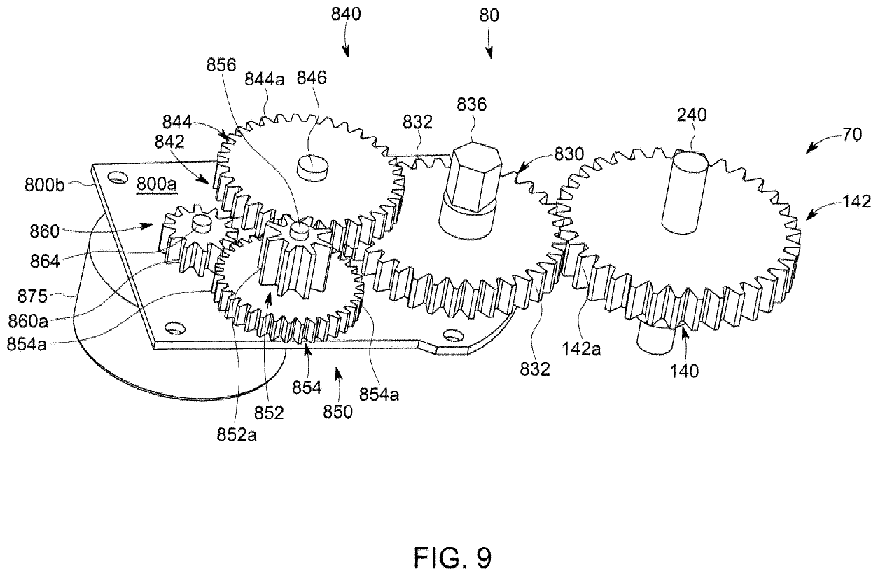

As best shown in FIG. 9, gear transmission system 80 is mechanically coupled to gear and ratchet system 70 and includes third gear 830, double gear assemblies 840 and 850, and gear 860. As shown therein, double gear 840 is mechanically coupled with third gear 830 and double gear 850. Double gear 840 comprises lower fourth gear 842 having teeth (not shown) engaging teeth 832 of third gear 830. Double gear 840 further comprises upper fifth gear 844 with teeth 844a.

Double gear 850 comprises upper sixth gear 852 with teeth 852a engaging teeth 844a of fifth gear 844. Double gear 850 further comprises lower seventh gear 854 with teeth 854a engaging teeth 860a of eighth gear 860. Eighth gear 860 is rotationally coupled to coil transformer 875 via shaft 864 to translate the rotational motion into electrical energy at the output of the transformer, as is understood in the art. Third gear 830, first double gear 840, and second double gear 850 are rotatable around shafts 836, 846, and 856, respectively, which are fixedly connected to a first surface 800a of support platform 800. In the disclosed embodiment, coil transformer 875 is disposed on second surface 800b opposite the first surface 800a. The gear train provides rotational velocity to spin the transformer or motor fast enough to generate sufficient electrical energy to power the device. Module 875 represents a transformer with winding, such as a spinning transformer with a permanent magnet.

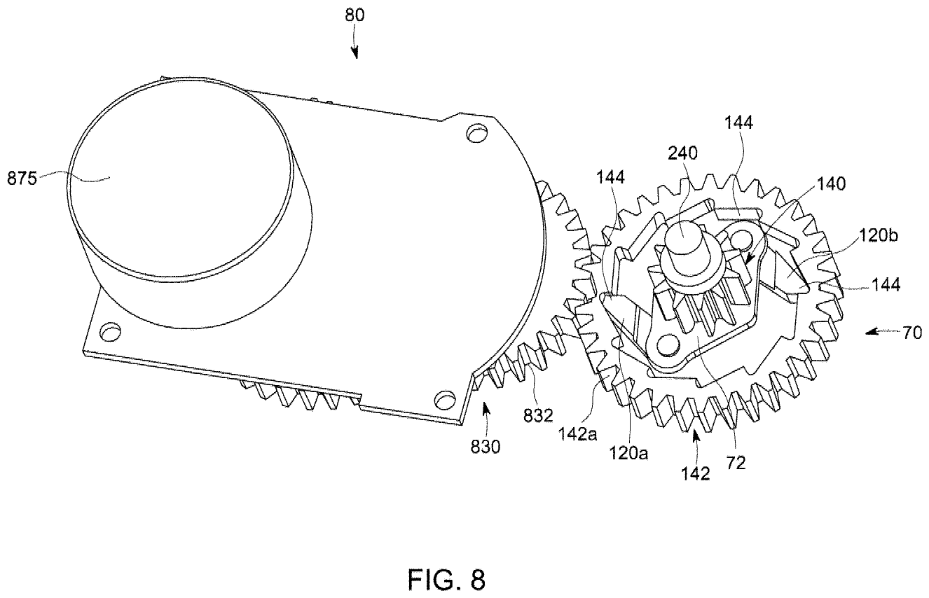

As best shown in FIG. 8, ratchet arm members 120a, 120b are preferably positioned 180 degrees apart and engage the corresponding ratchet pinion or grooves 144 to lock position so that the second gear cannot be reversed. That is, in one rotational direction (by depressing the handle in direction A), the ratchet arm members are configured to engage with the ratchet structure (FIG. 4A, 4B, and FIG. 5) to drive the second gear 140 in clockwise direction B. FIG. 5 shows depression of the handle toward the housing to the maximum extent. As shown in FIG. 6A, upon release of the handle 50, the bended spring 240 rebounds (D′) to drive the handle back (in direction A′). The teeth 54 on handle 50 drive first gear 140 to rotate oppositely (i.e. counterclockwise direction B″) and the ratchet arm members disengage from second gear 142 and slide over the ratchet structure (FIG. 6A) such that the second gear is not driven in the opposite or reverse direction. In an embodiment, a support platform 72 supports the first gear 140 and has the pair of ratchet arm members connected thereto. The support platform 72 with ratchet arm members is disposed on the surface of the second gear 142 and surrounded by the set of angled grooves or ratchet pinions 144 for unidirectional engagement with ratchet arm members 120a, 120b.

### Electronic Circuit Assembly

Referring now to FIGS. 10-12, in conjunction with FIG. 4A, the tire gage 10 includes electronic circuit assembly 110 configured on a printed circuit board (PCB) 112 within housing 20. The transformer 875 is electrically coupled to the electronic circuit assembly (FIG. 10). The electronic circuit assembly 110 comprises a large capacitance charging capacitor 1110 (e.g. 2200 microfarad (uF) capacitor), control processor 1160, and LCD 1100 (FIG. 11). The circuit further comprises a low dropout voltage regulator 1140, a charge pump low voltage detector 1120 for detecting when the capacitor voltage reaches a minimum threshold value, and a logic gate coupled to the input of the low dropout voltage regulator. The low dropout voltage regulator (LDO) 1140 maintains a uniform voltage for energizing the microprocessor controller 1160 responsive to the charge pump low voltage detector 1120 determining the capacitor 1110 voltage is above a minimum threshold value and an active ON signal from the logic gate is received.

In an embodiment of the disclosure, the charge pump low voltage detector 1120 is electrically coupled to the charging capacitor 1110 for converting an analog voltage signal output from the charging capacitor to a predetermined digital voltage value for input to the low dropout voltage regulator 1140 when the charge pump low voltage detector determines the capacitor voltage is above the minimum threshold value. The charge pump low voltage detector is further configured to generate a signal when the capacitor voltage is less than the minimum threshold value to cause the control processor 1160 to perform an operational shut down.

In the circuit diagram of FIG. 11, there is shown winding transformer or generator 875 electrically coupled to transistors Q2 and Q3 (e.g. NPN transistors) for providing a full bridge rectifier circuit. As is known in the art, a full bridge enables full wave voltage, thereby increasing the amplitude of the voltage output therefrom. Diode D3 operates to protect against any undesired reverse current. Capacitor 1110 (C3) is a relatively very large capacitor and represents the primary energy storage element and is charged by the circuit. Charge pump voltage converter 1120 is responsive to the large charge stored on large capacitor 1110 for energy transfer and voltage reduction to generate a reduced output voltage regulated to a predetermined level (e.g. 2.2 volt level) so that it can be used by processor 1160 (e.g. a microprocessor controller) operating at 2.2 volts.

In operation, responsive to squeezing of the handle 50 toward housing 20 to generate mechanical energy, an AC voltage output from generator or motor 875 is converted to DC volts via the charge pump 1120, and low dropout voltage (LDO) module 1140 is responsive to charge pump voltage converter 1120 for making it a regulated 3 volts DC.

In the circuit of FIG. 11, charge pump 1120 operates as a low voltage detector (i.e. drop out control), that enables the system to determine whether there is sufficient power in the circuit to perform the requisite functionality (e.g. taking pressure measurements, processing the data to determine requisite pressure values, activating and communicating with the display, etc.). Through implementation of large capacitor 1110 in conjunction with charge pump 1120, the system maintains the requisite energy level that avoids any pernicious “hanging conditions” or unrecoverable machine states by properly powering up (when sufficient energy exists) and/or powering down (when there is insufficient energy to continue active measurement processing, but still sufficient energy to perform a proper power down) of the circuit. The low power voltage detector 1120 provides monitoring of the energy level required, including regulated system voltages.

In an embodiment, the charge pump 1120 is implemented as an STM 1061 2.2V low power voltage detector manufactured by STMicroelectronics. A precision voltage reference and comparator monitors the VCC input and compares it with a specified voltage threshold condition. When VCC falls below a specified trip point threshold, the output (OUT) is forced low and remains asserted as long as the VCC input remains below VTH-+hysteresis (VHYST). The detector 1120 is configured to output the correct logic state for VCC down to 0.7V, as well as ignore fast transients on VCC.

Low drop out (LDO) voltage regulator 1140 is configured downstream of charge pump 1120 and responsive to the output of charge pump 1120 for making the output therefrom a regulated 3 volts. In an embodiment, LDO regulator 1140 is an XC6206P332MR LDO voltage regulator and having a fixed output positive low dropout (LDO) voltage regulator. The module operates as a highly precise, high voltage positive voltage regulator manufactured using CMOS and laser trimming technologies. The device provides large currents with significantly small dropout voltage. The LDO may include a current limiter circuit, driver transistor, precision reference voltage and an error correction circuit, and is compatible with low ESR ceramic capacitors. The current limiter's foldback circuit also operates as a short protect for output current limiter and output pin. Output voltage can be set internally by laser trimming.

This small, low power device is ideal for portable applications and is available in various space-saving packages (e.g. SOT23-3 and SOT323-3 (SC70-3) packages).

Referring still to FIG. 11, a very small resistor R11 is used as a protective impedance element (having a small impedance) to protect against a short circuit, such that the very large capacitor charges through a very small impedance (R11). The system is designed to put the maximum amount of voltage or energy charge onto the capacitor, without concern as to size, and then to use the small charge pump 1120 to reduce the voltage down to a level (i.e. regulate it to a predetermined (e.g. 2.2 Volt level) so that it can be used by a micro controller at 2.2 volts. As element 1120 is a small charge pump device that generates a DC voltage from an AC voltage output from the motor generator 875, the LDO module 1140 downstream from charge pump 1120 operates to generate a regulated output (line 5) of 3 volts.

Resistive element R12 and diodes D2 and D4 operate as a logic gate (OR gate) to keep the LDO voltage regulator 1140 ON, which keeps the microcontroller 1160 powered and energized for performing normal gauge operation, such as measurements of the pressure received at the nozzle, measurements of tread depth from the variable resistor circuitry, and display of the resultant measurements and units on the display.

### System Operation

As is understood from the present disclosure, the principle of the battery-free digital tire gauge is electromagnetic induction. In general, the coil generates induced electromotive force in the rotating magnetic field, with basic structural components of the “hand generator” including the stator and rotor. The stator is generally a permanent magnet and the rotor is a coil. When the inner coil passes through the brush to form a closed loop with the outer circuit, an electric current is formed in the circuit through the rectifier circuit with large capacitance (e.g. element 1100) to store electricity. In an embodiment, the minimum working voltage of the microcontroller unit 1160 (MCU) is 2.4V. The MCU (e.g. CSU8P1001) operates when the stored power is able to provide a voltage greater than 2.4V through an external LDO (e.g. XC6206P25) regulator. MCU internal LDO provides stable voltage of 2.8V for LCD and 2.4V for the sensor power supply. The MCU collects sensor analog signal data and calculates pressure values through internal analog-to-digital conversion, which is then displayed by LCD. When the power continues to drain and the LDO stabilized voltage drops below 2.4V, the MCU will stop working and the battery-free tire pressure gauge will shut down.

In operation, in order to keep the microprocessor controller in an active or ON state, a logic signal active (PT22) from the controller is needed and sufficient voltage (in excess of a predetermined threshold, e.g. 0.7V) is provided on the output line 1 of charge pump 1120. The microcontroller connection is PT22. Under these conditions, the LDO voltage regulator 1140 provides a uniform (e.g. 3V) output voltage signal for powering the microprocessor controller and enabling measurement and processing and display of the measured pressure received at the nozzle and/or the measured tired tread depth. The output (5) voltage signal of the LDO 1140 is further processed by means of downstream capacitors C2 (relatively large capacitor) and C1 (relatively small capacitor). Capacitor C2 (e.g. in the relative range of 1 uF capacitance) is designed to store or smooth the energy output by reducing the ripple or transient signals output from the LDO. Capacitor C1 (e.g., a ceramic capacitor in the relative range of 0.1 microfarad (uF) capacitance) is designed for alleviating higher frequency noise. In the system according to an embodiment of the disclosure, the motor is a noise generator that requires smoothing to reduce the noise. The microcontroller further includes software code or software algorithms that reduce the signal ripple and noise fluctuations.

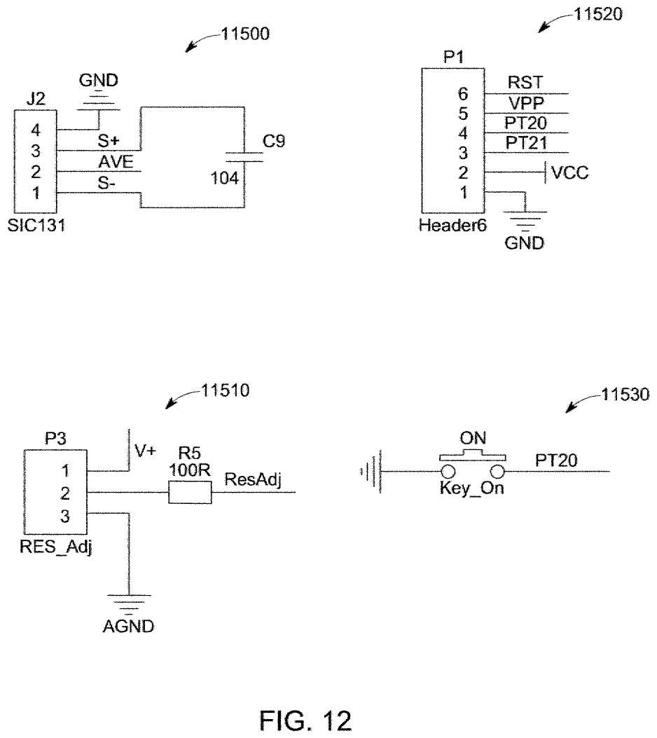

An exemplary microprocessor controller 1160 is illustrated in greater detail FIG. 11, along with various connections with related electronic components (FIG. 12) and electronic circuit 110 (FIG. 10). By way of example, display 100 may be embodied as LCD display circuit 1100 for displaying relevant unit values and measurement data resulting from the measured pressure and/or tread depth gauge measurements.

As shown in FIG. 12, sensor element circuit 11500 is an exemplary pressure sensor such as a MEMs die (e.g. manufactured by UniSense) for detecting the pressure received from the gauge nozzle 40 (FIG. 1).

Switch element circuit 11530 is a depressible switch element responsive to depression of button 530 on housing 20 (FIG. 1) for changing units on the display.

Memory circuit element 11580 (FIG. 11) is shown electrically coupled to microprocessor controller 1160 and embodied as an EEPROM for factory programming, to enable flashing and/or writing to memory, including calibration coefficients, by way of non-limiting example. Circuit element 11520 (FIG. 12) is a header that operates as an interconnect between circuit boards, including port lines and reset line that operates for purposes of programming the circuitry.

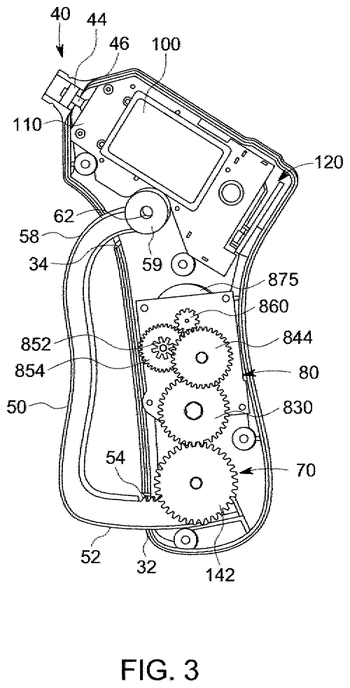

Circuit element 11510 (FIG. 13) represents a trim module which includes resistance adjustment module for trim for the tread depth module, such as to a slider pot for tread depth gauge 120 (FIG. 3).

### Operational Scenario

Referring to FIGS. 1-12, when a user squeezes the depressible handle in the substantially linear direction toward the handle body (FIG. 4A, 5), the spring 240 is bended, and the toothed rack on the handle drives the first gear 140 to rotate, which drives the ratchet rotating together. As the ratchet engages with the second gear 142, it drives the second gear rotating, and the engaged gear transmission system 830, 840, 850, 860 (third, fourth, fifth, sixth, seventh, and eight gears) rotate to generate mechanical motion that is transferred to electrical energy by transformer 875 to be stored in capacitor 1110. When there is enough power in capacitor 1110, a consistent (e.g. 3V) power through the LDO voltage regulator will activate the control processor.

In one embodiment of the present disclosure, there is provided an ultra-low clock and ultra-low power controller utilized in the configuration described herein, where the bridge or pressure sensor is being strobed to save power (i.e. intermittently powered) to maximize the amount of time the unit can remain on. As the bridge or sensor is essentially a resistor, it will drain power. Therefore, the microprocessor controller operates to strobe the sensor, by way of multiplexing, sampling, turning off, and then on in order to quickly obtain a reading. By operating the relatively few electronic components in the device in this fashion, and due to the reduced power level required resulting from the reduced number of electronic components and their relatively low power consumption requirements, there is very little self-heating, which also avoids further problems with the battery-free tire gauge device.

In an alternative embodiment, a stack of piezoelectric elements may be used in place of the transformer and gear transmission system to charge the charging capacitor 1110.

In a further alternative embodiment, the device includes a retention spring but the trigger, instead of running a motor and gear train, moves a magnet through a coil.

As previously discussed, in operation, the gauge 10 is powered on by depression of the handle 50 toward gauge body 30 connected via the gear and ratchet assembly 70 and the gear generator system 80 to generate mechanical motion within the housing which is translated to electrical energy sufficient to charge capacitor 1110 to enable a voltage to turn on the circuit (via the transformer, capacitor, charge pump, and LDO) and start up the microprocessor 1160 and corresponding electrical components. With the capacitor 1110 charged and the unit running, the microprocessor controller strobes the pressure sensor bridge (via the A/D controller) for detection of a pressure reading via sensor 11510.

Once the device senses a pressure, the number of counts are aggregated and factored by the microprocessor according to an algorithm (e.g. number of counts per psi), formatted, and the value written to the LCD controller, which displays the decimal digit equivalent of the internal pressure, as is understood by one skilled in the art. Similar processing occurs for tire tread measurements, as described herein above. As all of the processing performed in the tire gauge of the present disclosure is done without any battery, the environmental, regulatory, volatility, rechargeability, thermal, and temporal issues for on-demand measurements are minimized if not completely eliminated.

The tire gauge is calibrated to enable charging upon forced depression of the handle toward the body. The spring triggered retraction of the handle provides a fast response to reset the handle to the neutral or unbiased position, enabling additional biasing for operating the device, as needed. When the energy in the circuit 110 falls under a predefined level (e.g. after a timeout period), the display 100 will turn off. Circuit module 1120 is configured to protect the device against a lockup condition (e.g. by improperly powering down or improperly powering up the circuitry), wherein an indeterminate state or mode is entered from which the microprocessor cannot recover from. That is, when low voltage detector 1120 detects a voltage at its input less than a threshold condition (e.g. 0.7 v or 0.8 v, caused by the energy discharge of capacitor 1110), then detector 1120, via a logic signal, powers down the circuit 110, thereby avoiding a complete (or constant) drain of the circuit and avoiding a possible indeterminate state condition associated with the circuit. This avoids an oscillator or processor from shutting down and moving into an indeterminate state where one may not be able to recover from a low voltage condition.

### Operational Parameters

In one embodiment, operational range requirements of the battery-free tire gauge according to the present disclosure comprises:
1. Operation Range:
   a) Pressure: 5~99 psi/0.35~6.80 bar/35~680 kPa/0.4~7.00 kg/cm2;
   b) Depth: 0-15 mm/0- 19/32 inch;
2. Accuracy:
   a) Pressure: ±(1%+1 LSD);
   b) Depth: ±0.2 mm/ 1/32 inch;
3. Activation Pressure: >5 psi/0.35 bar/35 kPa/0.4 kg/cm2;
4. Measurement Units: psi/bar/kPa/kg/cm2/inch/mm;
5. Display format: 8.8/.8.8 PSI/BAR/KPA/Kg/cm²/INCH/MM;
6. Functions: Automatic Zero Tare and Automatic Shut Off.

### Pressure Measurement Mode

In an exemplary embodiment, a user squeezing the handle of the gauge generates sufficient mechanical to electrical energy to initialize (i.e. wake up) the gauge. The display will first flash a full screen initialization. The LCD display will show “0.0; 0.00 or 0” with last measurement mode and unit icon. If the last measurement mode was tread depth mode, depressing the “ON” button again causes the gauge to enter the pressure mode. Pressing and holding the ON button for a time T=2 seconds changes the unit, and the unit icon will blink (press ON to change unit psi/bar/kPa/kg/cm2 sequentially). If no further action is taken within time T=3 sec, the unit icon will stop blinking, indicating acknowledgement and confirmation of the selection. Next, by placing and holding the nozzle of the gauge onto the valve stem, the pressure reading is displayed. Upon removal of the gauge from the valve stem, the pressure reading is maintained on the LCD display. To convert the measure unit with pressure reading on the LCD, a user will push the “ON” button for time T=2 seconds to cause the current unit icon to activate (blink). Pressing the ON button selects the unit and causes the pressure reading to convert to the selected unit. Subsequently, the gauge will reset to zero and display zero (in relevant units) on the LCD display. The gauge will turn off after time T=1 minute from startup if the user does not further energize the gauge by squeezing the handle.

### Tread Depth Measurement Mode

In an exemplary embodiment, a user squeezing the handle of the gauge generates sufficient mechanical to electrical energy to initialize (i.e. wake up) the gauge. The display will first flash a full screen. The LCD display will show “0.0; 0.00 or 0” with last measurement mode and unit icon. If the last measurement mode was pressure mode, depressing the “ON” button again causes the gauge to enter the tread depth mode. Pressing and holding the ON button for a time T=2 seconds changes the depth measure units, and the unit icon will blink (press ON to change unit INCH/MM sequentially). If no further action is taken within time T=3 sec, the unit icon will stop blinking, indicating acknowledgement and confirmation of the selection (if needed later, press ON again to measure tire pressure). Next, slide the button on the side of the gauge housing until the metal rod touches the bottom of the groove. Push the gauge down towards the tire until the flat surface of the gauge on the tread surface, and then the tire depth reading is displayed. The gauge will turn off after time T=1 minute from startup if the user does not further energize the gauge by squeezing the handle.

It should be noted that embodiments of the present invention may include any number of additional components not shown in the simplified schematics illustrated herein for the purposes of brevity.

Thus, there is disclosed a battery-free digital tire gauge for measuring at least one parameter associated with a tire, comprising: a housing; an electronic circuit assembly in the housing including at least one sensor for measuring at least one parameter associated with a tire. The electronic circuit assembly further comprises a control processor, a display coupled to the control processor, and a charging capacitor. A transformer is coupled to a gear and ratchet assembly for transforming mechanical motion to electrical energy. A depressible handle (50) is operatively coupled to the housing, the depressible handle mechanically coupled to the gear and ratchet assembly located in the housing such that depression of the handle towards the housing drives the gear and ratchet assembly to generate mechanical motion that is transformed into electrical energy by the transformer. The transformed electrical energy resulting from the driven gear and ratchet assembly charges the capacitor in the housing to energize the microprocessor in the electronic circuit assembly and cause the at least one sensor to measure the at least one parameter associated with a tire and display the at least one measured parameter on the display.

In one embodiment of the battery-free digital tire gauge, the housing comprises a body portion adapted to be held in the hand of a user and including an opening for receiving the end portion of the depressible handle; and wherein when the depressible handle is grasped in the hand of a user and squeezed in a substantially linear direction toward the body portion, the gear and ratchet assembly generates mechanical motion that is transformed into electrical energy by the transformer to charge the capacitor and energize the control processor in the electronic circuit assembly to enable the at least one sensor to measure at least one parameter associated with a tire and display the at least one measured parameter on the display.

In an embodiment, the electronic circuit assembly further comprises: a low dropout voltage regulator; a charge pump low voltage detector for detecting when the capacitor voltage reaches a minimum threshold value; and a logic gate coupled to the input of the low dropout voltage regulator; wherein the low dropout voltage regulator maintains a uniform voltage for energizing the microprocessor controller responsive to the charge pump low voltage detector determining the capacitor voltage is above a minimum threshold value and an active ON signal from the logic gate.

In an embodiment, the depressible handle comprises an end portion including a toothed rack; and wherein the toothed rack of the depressible handle is mechanically coupled to the gear and ratchet assembly located in the housing such that depression of the handle towards the body causes the toothed rack to drive the gear and ratchet assembly to generate the mechanical motion that is transformed into electrical energy by the transformer.

In an embodiment, the gear and ratchet assembly further comprises: a first gear including a ratchet driving part; a second gear including a ratchet structure; wherein the ratchet driving part is configured for engaging with the ratchet structure of the second gear and driving the second gear to rotate in a first direction in response to squeezing of the depressible handle toward the housing to cause the toothed rack to drive the first gear to rotate in the first direction.

In an embodiment, upon release of the depressible handle, a spring force causes retraction of the depressible handle to a nominal position, the toothed rack driving the first gear to rotate counter to the first direction, while the ratchet driving part slides counter to the ratchets of the ratchet structure of the second gear, thereby, preventing counter rotation of the second gear.

In an embodiment, the ratchet driving part comprises a pair of ratchet arm members. In an embodiment, the pair of ratchet arm members are positioned 180 degrees apart and connected to the first gear.

In an embodiment, a support platform that supports the first gear has the pair of ratchet arm members connected thereto.

In an embodiment, the support platform with ratchet arm members is disposed on a surface of the second gear and surrounded by the set of angled teeth, wherein the ratchet arm members are engageable with the set of angled teeth to rotate the second gear when the toothed rack is engaged with the first gear in a first rotational direction.

In an embodiment, the gear and ratchet assembly further comprise a plurality of transmission gears operatively coupled between the second gear and the transformer, wherein a first transmission gear of the plurality of transmission gears engages with and is rotatably driven by the second gear, and wherein a last transmission gear of the plurality of transmission gears engages with and drives a shaft of the transformer.

In an embodiment, the spring force comprises a metal spring coupled to an end portion of the depressible handle.

In an embodiment, the plurality of transmission gears further comprises first and second sets of double gears coupled between the first transmission gear and the last transmission gear.

In an embodiment, the battery-free digital tire gauge further comprises a ripple filter comprising a second capacitor coupled to the output of the LDO voltage regulator and configured to reduce the ripple voltage input to the control processor.

In an embodiment, the battery-free digital tire gauge further comprises a noise filter comprising a third capacitor coupled to the output of the LDO voltage regulator and configured to reduce the high frequency noise.

In an embodiment, the charging capacitor has a capacitance at least 1000 times the capacitance of the second capacitor.

In an embodiment, the second capacitor has a capacitance at least 100 times the capacitance of the third capacitor.

The exemplary illustrations are provided by way of example only, and other embodiments for implementing the processes described herein may be contemplated by one of skill in the pertinent art without departing from the intended scope of this disclosure. For example, the processes may be implemented, by way of example, by memory containing instructions, the instructions when executed by a processor, cause the steps of the described methods for measuring tire pressure and/or tread depth to be performed. It is understood that these may also be performed in hardware. Thus, the entire process or any part thereof, may be performed in hardware, software or any combination of hardware and/or software. Software may be embodied in a non-transitory machine readable medium upon which software instructions may be stored, the stored instructions when executed by a processor cause the processor to perform the steps of the methods described herein. Further, while a depressible handle and rack in conjunction with a gear and ratchet assembly and transformer generator has been shown and described for conveying electrical energy to the charging capacitor for powering the electronic circuit assembly and control processor, it is contemplated that the mechanical motion may be imparted to energize a piezoelectric (or piezoceramic) generator such as a PZT stack or other configuration, which may be subject to a vibrational force or impact, a coil and magnet in relative rotational motion, or other transformer device, which may be impacted by the mechanical motion to generate electrical energy within the housing for powering the control processor, sensors, detectors, and the like.

While the foregoing invention has been described with reference to the above-described embodiment, various modifications and changes can be made without departing from the spirit of the invention. Accordingly, all such modifications and changes are considered to be within the scope of the appended claims. Accordingly, the specification and the drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations of variations of various embodiments. Combinations of the above embodiments, and other embodiments not specifically described herein, will be apparent to those of skill in the art upon reviewing the above description.

1. A battery-free digital tire gauge for measuring at least one parameter associated with a tire, comprising:
a housing;
an electronic circuit assembly in said housing including at least one sensor for measuring at least one parameter associated with a tire, the electronic circuit assembly further comprising a control processor, a display coupled to said control processor, and a charging capacitor;
a transformer coupled to a gear and ratchet assembly for transforming mechanical motion to electrical energy;
a depressible handle operatively coupled to the housing, the depressible handle mechanically coupled to the gear and ratchet assembly located in the housing and having a retention spring such that depression of the handle towards the housing drives the gear and ratchet assembly to generate mechanical motion that is transformed into electrical energy by the transformer;
wherein the transformed electrical energy resulting from said driven gear and ratchet assembly charges said capacitor in said housing to energize a control processor of said electronic circuit assembly and cause said sensor to measure the at least one parameter associated with a tire and display said at least one measured parameter on said display.

2. The battery-free digital tire gauge of claim 1, wherein the housing comprises a body portion adapted to be held in the hand of a user and including an opening for receiving the end portion of the depressible handle;
and wherein when the depressible handle is grasped in the hand of a user and squeezed in a substantially linear direction toward the body portion, the gear and ratchet assembly generates mechanical motion that is transformed into electrical energy by the transformer to charge said capacitor and energize the control processor in the electronic circuit assembly to enable the at least one sensor to measure at least one parameter associated with a tire and display said at least one measured parameter on said display.

3. The battery-free digital tire gauge of claim 1, wherein the electronic circuit assembly further comprises:
a low dropout voltage regulator;
a charge pump low voltage detector for detecting when the capacitor voltage reaches a minimum threshold value; and
a logic gate coupled to the input of the low dropout voltage regulator;
wherein the low dropout voltage regulator maintains a uniform voltage for energizing the microprocessor controller responsive to the charge pump low voltage detector determining the capacitor voltage is above the minimum threshold value and an active ON signal from the logic gate.

4. The battery-free digital tire gauge of claim 1, wherein the depressible handle comprises an end portion including a toothed rack; and wherein the toothed rack of the depressible handle is mechanically coupled to the gear and ratchet assembly located in the housing such that depression of the handle towards the body causes the toothed rack to drive the gear and ratchet assembly to generate said mechanical motion that is transformed into electrical energy by the transformer.

5. The battery-free digital tire gauge of claim 4, wherein the gear and ratchet assembly comprises:
a first gear including a ratchet driving part;
a second gear including a ratchet structure;
wherein the ratchet driving part is configured for engaging with the ratchet structure of the second gear and driving the second gear to rotate in a first direction in response to squeezing of the depressible handle toward the housing to cause the toothed rack to drive the first gear to rotate in said first direction.

6. The battery-free digital tire gauge of claim 5, wherein, upon release of the depressible handle, a spring force exerted by the retention spring causes retraction of the depressible handle to a nominal position, the toothed rack driving the first gear to rotate counter to said first direction, while the ratchet driving part slides counter to the ratchets of the ratchet structure of said second gear, thereby, preventing counter rotation of the second gear.

7. The battery-free digital tire gauge of claim 6, wherein the gear and ratchet assembly further comprises a plurality of transmission gears operatively coupled between the second gear and the transformer, wherein a first transmission gear of said plurality of transmission gears engages with and is rotatably driven by said second gear, and wherein a last transmission gear of said plurality of transmission gears engages with and drives a shaft of said transformer.

8. The battery-free digital tire gauge of claim 6, wherein the spring force comprises a metal spring coupled to an end portion of the depressible handle.

9. The battery-free digital tire gauge of claim 7, wherein the plurality of transmission gears further comprises first and second sets of double gears coupled between said first transmission gear and said last transmission gear.

10. The battery-free digital tire gauge of claim 5, further comprising a ripple filter comprising a second capacitor coupled to the output of said LDO voltage regulator configured to reduce the ripple voltage input to the control processor.

11. The battery-free digital tire gauge of claim 5, further comprising a noise filter comprising a third capacitor coupled to the output of said LDO voltage regulator configured to reduce the high frequency noise.

12. The battery-free digital tire gauge of claim 11, wherein the second capacitor has a capacitance at least 100 times the capacitance of the third capacitor.

13. The battery-free digital tire gauge of claim 2, wherein the at least one sensor comprises a pressure sensor, and wherein the housing comprises a nozzle for communicating fluid pressure from a tire to the pressure sensor for measurement and display.

14. The battery-free digital tire gauge of claim 2, wherein the at least one sensor comprises a tread depth sensor having an adjustable rod and variable resistor in said housing for engaging with a tire for measurement and display of tread depth.

15. The battery-free digital tire gauge of claim 2, wherein the at least one sensor comprises a pressure sensor and a tread depth sensor.

16. A method for operating a battery-free digital tire gauge, the method comprising:
applying a squeezing force to a depressible handle of a tire gauge housing;
generating mechanical motion by driving a gear and ratchet assembly located in the housing with a toothed rack on the depressible handle in response to the squeezing force;
transforming the mechanical motion into electrical energy via a transformer mechanically coupled to the gear and ratchet assembly;
charging a charging capacitor in the housing with the transformed electrical energy; and
energizing a control processor in an electronic circuit assembly using a predetermined voltage from the charged capacitor to enable a sensor to measure at least one parameter associated with a tire and display the at least one measured parameter on a display.

17. The method of claim 16, further comprising:
detecting when the charging capacitor voltage reaches a minimum threshold value using a charge pump low voltage detector; and
enabling a low dropout voltage regulator to provide a uniform voltage for energizing the control processor in response to the charge pump low voltage detector determining the capacitor voltage is above the minimum threshold value.

18. The method of claim 16, further comprising:
releasing the depressible handle, wherein a spring force causes retraction of the handle to a nominal position; and
preventing counter-rotation of the gear and ratchet assembly using a ratchet structure during retraction of the handle.

19. The method of claim 16, wherein the at least one parameter associated with a tire is tire pressure, and the method further comprises:
communicating fluid pressure from a tire to a pressure sensor; and
converting the fluid pressure into an electrical signal using the pressure sensor, which comprises a MEMs die.

20. The method of claim 16, wherein the at least one parameter associated with a tire is tire tread depth, and the method further comprises:
engaging a movable rod or plunger with a tire to measure tread depth; and
converting a mechanical displacement of the movable rod or plunger into an electrical analog signal using a variable resistor.
